(19) United States
(12) Patent Application Publication
(10) Pub. No.: US 2003/0041303 A1
(43) Pub. Date: Feb. 27, 2003

(54) System and method for tracking placement and usage of content in a publication

(76) Inventor: John R. Milton, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/938,465

(22) Filed: Aug. 23, 2001

(51) Int. Cl. G06F 7/00

(52) U.S. Cl. 715/513

(57) ABSTRACT

A method, a program embodied in a computer readable medium, and a system for tracking a placement of content in a publication are provided. In one embodiment, for example, the method includes the step of detecting at least one placement tag associated with a content element in a computer system, the content element comprising at least a portion of a content item to be placed in the publication. The method also includes the steps of determining at least one position in the publication at which the content element is placed when the at least one placement tag is detected, and, generating a placement report that logs the at least one position of the content element within the publication.

### TECHNICAL FIELD

The present invention is generally related to the field of digital publishing and, more particularly, is related to a system and method for tracking placement and usage of content in a publication.

### BACKGROUND OF THE INVENTION

In the mid 1400's, Johann Gutenberg revolutionized how information is disseminated through his invention of the movable type press. With the publication of the Mazarin Bible, documents which were once held in the exclusive domain of a chosen few were now widely available to the masses. Nearly 550 years later, the mass media revolution that Gutenburg started is alive and well, complete with newspapers such as the New York Times and the Washington Post, magazines such as Newsweek and Sports Illustrated, and literally thousands upon thousands of other lesser known publications.

While these thousands of publications cover a wide range of interests, from news to sports to fashion to model rocketry, they have one thing in common in that they are intended to be read by a mass market. Unlike the pre-Gutenberg days, where a document would literally be read by only one person or a very small number of people, it is not economically viable for today's publications to have such a small readership, due at least in part to high marketing, production and distribution costs. In fact, many of today's publications are funded to a very large extent by the advertising contained within them. These advertisers are attracted to publications that can consistently deliver a large, reliable audience of consumers that will be exposed to their advertising.

While this mass market publication model has worked well for hundreds of years, it is not without its problems. One such problem is that a typical reader of a publication has a wide variety of interests, and no single mass market publication will be able to satisfy all these interests. For example, a reader who is interested in international news, golf, fly fishing, genealogy, and computers may have to subscribe to several different publications to satisfy these interests. Of course, since these publications are intended for a mass market, they will also contain a significant amount of material including articles, advertising, and other content that does not hold our reader's interest. Consequently, our reader will ignore such material and a significant amount of paper is wasted. Advertisers know this, and agree to pay considerably less to mass market magazine or newspaper per 1000 exposures to their ad than they would pay to a direct-mail generator that provides a more specific guarantee that the people exposed to their ad are of a demographic group that will be much more likely to read their ad and be interested in it.

In addition, it is neither cost-effective nor time effective for most readers to subscribe to and/or read a large number of publications. Generally, the typical reader will only subscribe to a few publications that are of the most interest to them. The reader reduced readership level of the publications our typical reader chooses not to subscribe to, even though he would be interested in at least some of the editorial and advertising content contained inside, means that the publication receives less subscription and advertising revenue than they otherwise would. If many other readers make the same decision, the continued health of the publication may be in jeopardy, and the publication may be forced to go out of business. In fact, many publications do go out of business yearly for failing to attract a sustaining number of advertisers and readers. This occurs even if there are a large number of readers that would be interested in reading their publication, and a corresponding number of advertisers anxious to have these readers exposed to their ads. In general, publications that fail to attract a substantial mass market of people willing to pay for and/or read them cease publication. This is a shame, since many of these publications would enrich the diversity of information available to all readers, and would provide an avenue for lesser known writers and artists to practice their wares.

In more recent years, a new type of publication has emerged, namely, the personalized publication. Readers of these publications typically sign onto the Internet through their computer or other network capable device, and read the publications online or have the publication downloaded and printed on a printer. These publications are “personalized” in that many allow readers to state personal preferences on what type of material they want to read. Articles, advertising, and other content items are then included in the personalized publication, thus creating a publication that is of specific interest to a specific reader. Often, these personalized electronic publications include advertising in various locations.

A specific personalized publishing service can now generate thousands if not millions of personalized publications each day. In cases where the provider of the personalized publishing service derives revenue by including advertisements in the personalized publications, the placement of advertisements within a publication may directly effect revenue derived from such use. Specifically, an advertisement that appears on the front page of a publication may derive more revenue than if placed on the last page, etc. Unfortunately, current personalized publishing services do not track the placement of advertisements so that the revenue may be properly calculated.

### SUMMARY OF THE INVENTION

In light of the forgoing, the present invention provides for a method, a program embodied in a computer readable medium, and a system for tracking a placement of content in a publication. In one embodiment, for example, the method includes the step of detecting at least one placement tag associated with a content element in a computer system, the content element comprising at least a portion of a content item to be placed in the publication. The method also includes the steps of determining at least one position in the publication at which the content element is placed when the at least one placement tag is detected, and, generating a placement report that logs the at least one position of the content element within the publication.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block of a publication distribution network according to an aspect of the present invention;

FIG. 2 is a block diagram of the operation of the publication distribution network of FIG. 1;

FIG. 3 is a drawing of a content item placed in a publication distributed via the publication distribution network of FIG. 1, where the content item includes a content element that comprises at least a portion of the content item;

FIG. 4 is a drawing of a placement report that details at least one position of the content element of in the publication distributed via the publication distribution network of FIG. 1; and

FIG. 5 is a flow chart of a placement report generator that is executed in a publishing server in the publication distribution network of FIG. 1.

### DETAILED DESCRIPTION OF THE INVENTION

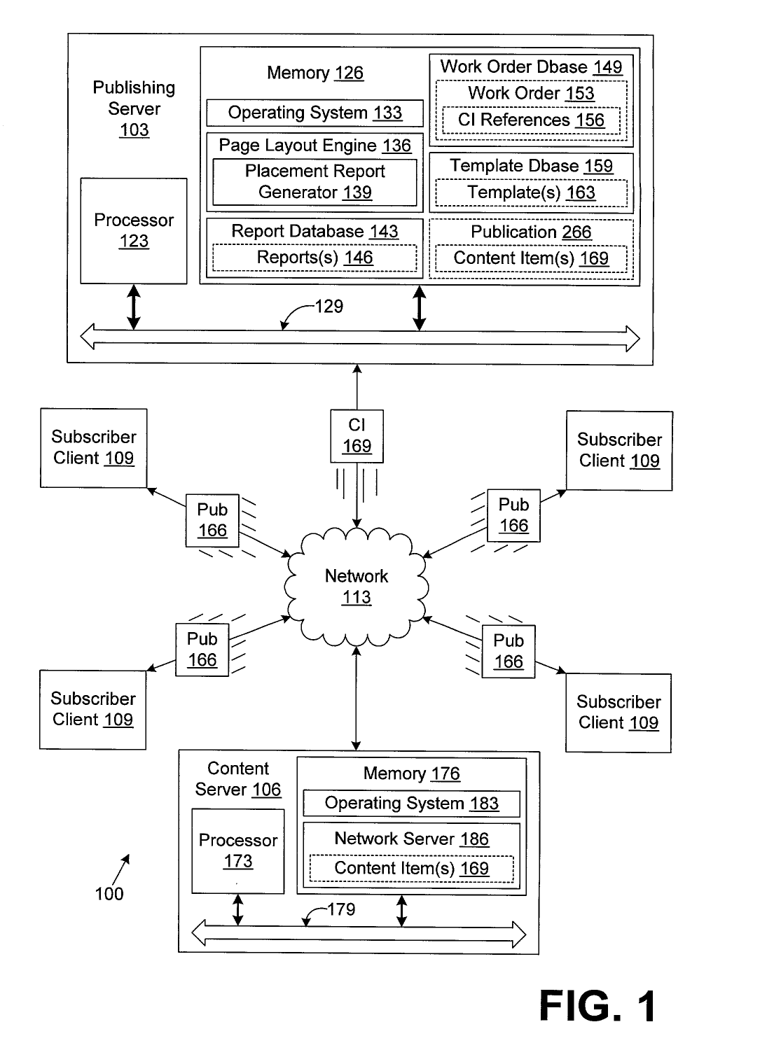

With reference to FIG. 1, shown is a publication distribution network 100 according to an aspect of the present invention. The publication distribution network 100 is employed to distribute a number of publications to a number of clients as will be described. This is done while at the same time, the placement of various content items within these publications is tracked so that such placement may be determined upon future inquiry. In the discussion that follows, first a physical description of the publication distribution network 100 is provided followed by a description of the operation of the publication distribution network 100.

The publication distribution network 100 includes a publishing server 103, a content server 106, and one or more subscriber clients 109. The publishing server 103, content server 106, and subscriber clients 109 are all coupled to a network 113. The publishing server 103, content server 106, and one or more subscriber clients 109 may be, for example, computer systems or devices with like capability.

The network 113 includes, for example, the Internet, wide area networks (WANs), local area networks, wireless networks, or other suitable networks, etc., or any combination of two or more such networks. The publishing server 103, content server 106, and subscriber clients 109 are coupled to the network 113 to facilitate data communication to and from other devices on the network 113. In this respect, the publishing server 103, content server 106, and subscriber clients 109 may be linked to the network 113 through various devices such as, for example, network cards, modems, routers, or other communications devices.

The publishing server 103 includes a processor circuit having a processor 123 and a memory 126, both of which are coupled to a local interface 129. The local interface 129 may comprise, for example, a data bus with an accompanying control/address bus as can be appreciated by those with ordinary skill in the art. Stored on the memory 126 and executable by the processor 123 are an operating system 133 and a page layout engine 136. The page layout engine 136 includes a placement report generator 139. The placement report generator 139 may be, for example, encapsulated in a separate module that is manipulated by the page layout engine 136, or it may be integrated into the functionality of the page layout engine 136 itself. A more detailed description of the operation of these components will be provided in text that follows. Also stored on the memory 126 and accessible by the processor 123 is a report database 143 having one or more placement reports 146 and a work order database 149 that includes one or more work orders 153. Alternatively, the report database 143 may comprise a file rather than a database that incorporates the placement reports 146. Each of the work orders 153 may include a content item reference 156. Also stored on the memory 126 is a template database 159 having a number of templates 163 and a publication 166 that includes one or more content items 169. Ultimately, the publication 166 is created by the page layout engine 136 as will be discussed. The use of the various databases and items stored within each database will be described in later text.

The content server 106 also includes a processor circuit having a processor 173 and a memory 176, both of which are coupled to a local interface 179. The local interface 179 may be, for example, a data bus with an accompanying control/address bus as is generally known by those with ordinary skill in the art.

Stored on the memory 176 and executable by the processor 173 are an operating system 183 and a network server 186. Stored on the network server 186 are content items 169 that may be served up to the publishing server 103 through the network 113. Specifically, the content server 106 may operate as a Hypertext Transfer Protocol (HTTP) server and the publishing server 103 may act as an HTTP client as can be appreciated by those with ordinary skill in the art. Also other protocols besides HTTP may be employed.

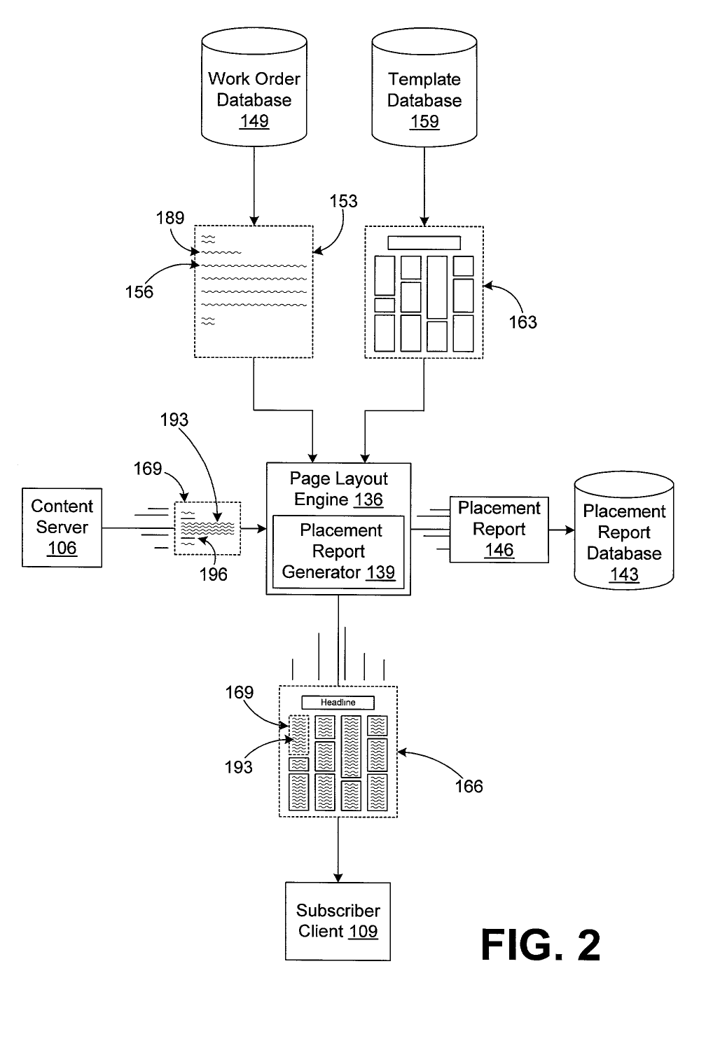

The publishing server 103 obtains the content items 169 from the one or more content servers 106 on the network 113 and generates a publication 166 therefrom. This publication 166 is then transmitted to one or more subscriber clients 109 via the network 113. A further description of the operation of the publication distribution network 100 is provided with reference to FIG. 2.

Note that the publishing server 103, content server 106, and one or more subscriber clients 109 each may include various peripheral devices, such as, for example, a keyboard, keypad, touch pad, touch screen, microphone, scanner, mouse, joystick, or one or more push buttons, etc. Such peripheral devices may also include display devices, indicator lights, speakers, printers, etc. Specific display devices may be, for example, cathode ray tubes (CRTs), liquid crystal display screens, gas plasma-based flat panel displays, or other types of display devices, etc.

Each of the memories 126 and 176 may include both volatile and nonvolatile memory components. Volatile components are those that do not retain data values upon loss of power. Nonvolatile components are those that retain data upon a loss of power. Thus, each of the memories 126 and 176 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 123 and 173 may represent multiple processors and each of the memories 126 and 176 may represent multiple memories that operate in parallel processing circuits, respectively. In such a case, each of the local interfaces 129 and 179 may be an appropriate network that facilitates communication between any two of the multiple processors, between any processor and any of the memories, or between any two of the memories, etc. The processors 123 and 173 may be electrical or optical in nature.

The operating systems 133 and 183 are executed to control the allocation and usage of hardware resources in the publishing server 103 and the content server 106, respectively. Specifically, the operating systems 133 and 183 control the allocation and usage of processing time, any peripheral devices, and the memories 126/176, as well as performing other functionality. In this manner, the operating systems 133 and 183 serve as the foundation on which applications depend as is generally known by those with ordinary skill in the art.

With reference to FIG. 2, shown is a block diagram of what depicts the operation of the publication distribution network 100 (FIG. 1) in generating the publication 166 and in generating the placement reports 146 that indicate the placement of the various content elements within the publications 166. To begin, a work order 153 is obtained from the work order database 149. The work order 153 thus keeps a record of the subscriptions that are ultimately fulfilled. The work order includes a number of content item references 156 and a template reference 189. Thus, the work order 153 generally contains the information needed to generate the publication 166. In this respect, the content item references 156 may be, for example, uniform resource indicators (URI) that point to a specific content item stored in the content server 106. The content item references 156 may be to one or more multiple content servers 106, wherever the content items 169 are stored.

The template reference 189 refers to a specific template 163 that is stored in the template database 159. The template 163 includes layout information that is to be employed to create the resulting publication 166. In particular, to create the publication 166, the page layout engine 136 “populates” the template 163 with the content items 169 referenced by the work order 153.

Although the work order 153 is shown as stored in the work order database 149, alternatively the work order 153 may be stored in a different device or computer system on the network 113 (FIG. 1). In such case, the work order 153 would be provided to the page layout engine 136 by the respective device. Note that the work order 153 may be applied to the page layout engine 136 according to a predefined schedule or upon request generated by one of the subscriber clients 109 as can be appreciated by those with ordinary skill in the art.

Once the page layout engine 136 obtains the work order 153, it proceeds to obtain all of the content items 169 identified by the content item references 156 and the template 163 that is identified by the template reference 189. Specifically, the content items 169 are obtained from the respective content servers 106, for example, and the template 163 is obtained from the template database 159. Note that the content items 169 may also be stored in and obtained from the publishing server 103 (FIG. 1) and the template 189 may be stored in and obtained from other devices coupled to the network 113.

Associated with the content item 169 are one or more content elements 193. Specifically, the content element 193 may comprise any portion of the content item 169 or the content element 193 may be the entire content item 169. To explain, assume that the content item 169 comprises an article written by a specified author. In this respect, the content element 193 may include the entire article or it may include any portion of the article such as, for example, a number of words in the article itself like the title or other portion. In any event, according to an aspect of the present invention, the one or more positions at which the content element 193 is placed is obtained and recorded for future inquiry. For purposes of facilitating the discussion that follows, it is assumed herein that the content element 193 is the entire article that is contained within the content item 169, it being understood that the this assumption does not limit the content element 193 to the entire article.

The content item 169 may also include one or more placement report tags 196. The placement report tags 196 are associated with the content element 193 of the content item 169. The placement report tags 196 ultimately trigger the creation of a placement report 146 that includes the position in the publication 166 where the content element 193 was placed by the page layout engine 136. The placement report tags 196 may be associated with the content element 169 in one of a number of ways. For example, the content element 169 may lie between a pair of related placement report tags 196. Also, a placement report tag 196 may be included as an attribute of a particular content element 169, etc.

Upon receiving the work order 153, the page layout engine 136 then obtains the corresponding template 163 and all of the associated content items 169 that are specified by the content item references 156 and the template reference 189 in the work order 153. The page layout engine 136 then proceeds to populate the template 163 with all of the content items 169. As a result, the publication 166 is created in digital form that is then transmitted to the subscriber client 109 for viewing or printing as is appropriate.

When the page layout engine 136 encounters one or more placement report tags 196 while populating a respective content item 169 into the publication 166, then the page layout engine 136 calls the placement report generator 139 to generate a corresponding placement report 146. In generating the placement report 146, the placement report generator 136 obtains the one or more locations at which the respective content element 193 is placed in the publication 166 from the page layout engine 136. This position may be expressed, for example, in terms of rectangular coordinates on the publication 166 or using some other coordinate system. Also, the area populated by the content element 193 may be expressed, for example, in terms of a height and width, etc. In situations where a content element 193 is positioned in multiple locations in one or more columns and on one or more pages of a publication 166, then the various pages, positions, and areas where portions of the content element 193 are placed may be identified by corresponding sets of coordinates and areas, etc.

In generating the placement report 146, the placement report generator 139 first creates an instance of a blank placement report. Then, the position information of the content element 193 in the publication 166 is written to the placement report 146 that is then stored in the placement report database 143 or file, etc. Also, the placement report identifier 199 (FIG. 4) is written to the blank placement report 146 as well as any other information.

The placement report generator 139 provides additional functionality that is implemented during the course of the operations of the page layout engine 136 in order to generate placement reports 146 that log where respective content items 169 were positioned in the publication 166. In this manner, a record of placement of respective content items 169 is created and stored in the placement report database 143. Thereafter, the placement reports 146 may be accessed to determine how often a particular content element 193 was employed, as well as where the content element 193 was employed in the respective publications 166.

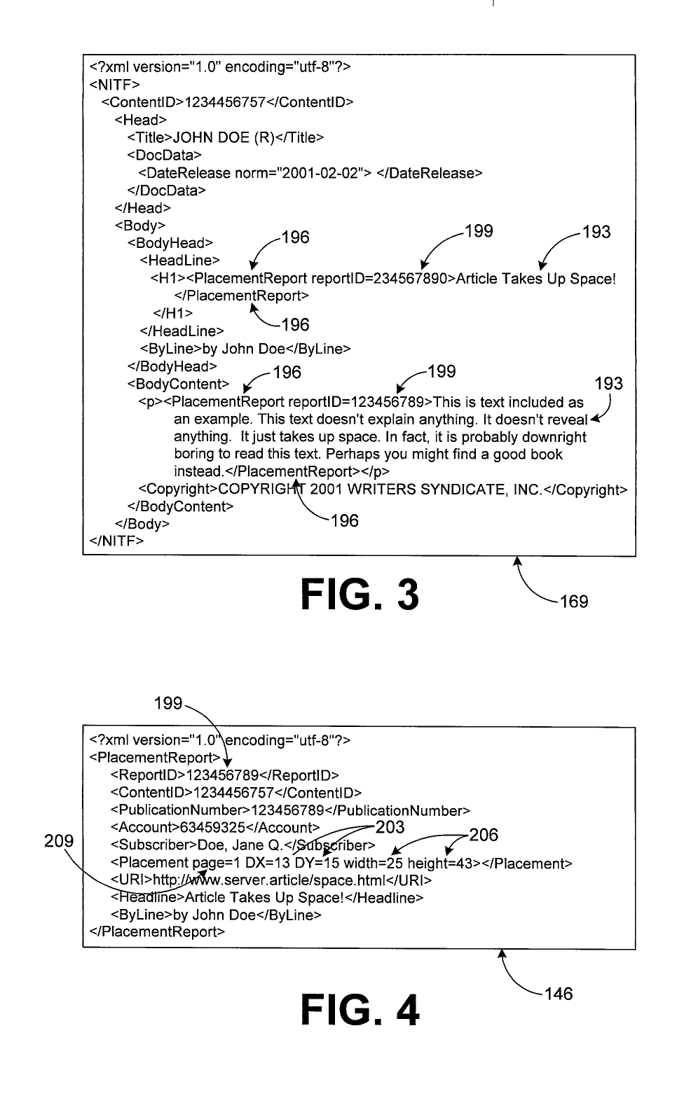

With respect to FIG. 3, shown is an example of a content item 169 according to an aspect of the present invention. The content item 169 is expressed, for example, as an extensible mark-up language file (XML) according to a specific data type description (DTD). Specifically, the content item 169 is an article that is expressed, for example, in a format similar to the News Industry Text Format (NITF), only with a few changes as will be discussed. The NITF was developed by the International Press Telecommunications Council headquartered in the United Kingdom to define the content and structure of news articles and other content items 169. The content item 169 of FIG. 3 is thus provided as one example of the multiple different kinds of content items 169 that may be employed herein. For example, the content item 169 may also comprise, for example, an image, an article, or other matter.

The content item 169 includes placement report tags 196 that are associated with respective content elements 193. As shown, one of the content elements 193 is the title of the respective article, and the other content element 193 is the actual text of the article. Associated with each of the placement report tags 196 is a placement report identifier 199 that uniquely identifies both the respective placement report tags 196 and the content element 193 associated therewith. As shown in FIG. 3, the placement report identifier 199 is an attribute of the placement report tags 196, although the placement report identifier 199 may also be expressed in some other manner. Thus, when the page layout engine 136 populates this respective content element into the publication 166, two placement reports 146 will be created by the placement report generator 139. Specifically, the placement of the title and the placement of the text of the article set forth in the content item 169 will be noted in respective placement reports 146 that are stored in the placement report database 143.

With respect to FIG. 4, shown is a placement report 146 according to an aspect of the present invention. As shown, the placement report 146 includes the placement report identifier 199. By including the placement report identifier 199, the placement report 146 is associated with the respective content element 193. The placement report 146 also includes the rectangular coordinates 203 and the area 206 that denote the position of the content element 193 in the publication 166 (FIG. 2). Also, the placement report 146 indicates a page 209 upon which the corresponding content element 193 is placed in the publication 166 where the publication 166 comprises multiple pages.

Note that other information may be contained in the placement report 146 as needed, including, an identifier associated with the content item 169 such as, for example, the content item reference 156 (FIG. 2) or other information. Also, the respective number or other identifier associated with the publication 166 may be included. Ultimately, the other information that may be included in the placement report 146 beyond the placement report identifier 199, rectangular coordinates 203, area 206, and the number of pages 209 may be predetermined by the entity that maintains the publishing server 103 as can be appreciated by those with ordinary skill in the art.

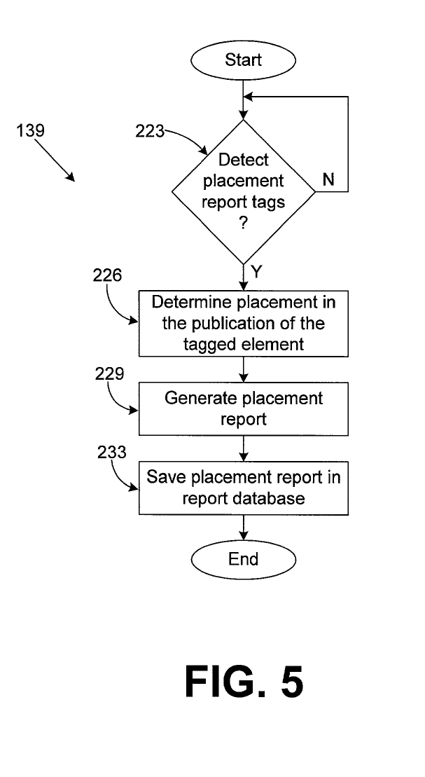

Turning then to FIG. 5, shown is a flow chart of the placement report generator 139, according to an aspect of the present invention. Alternatively, the flow chart of FIG. 5 may be viewed as depicting steps in a method implemented in the publishing server 103 (FIG. 1) in generating the placement reports 146 (FIG. 1).

Beginning with block 223, the placement report generator 139 waits until a respective placement report tag 196 (FIG. 3) is encountered in a content item 169 (FIG. 3) to be populated into a particular publication 166 (FIG. 2). The placement report generator 139 knows that a respective placement report tag 196 has been encountered, for example, when the page layout engine 136 (FIG. 1) informs the placement report generator 139 that placement report tags 196 were encountered during the placement of a respective content item 169.

Assuming that at least one placement report tag 196 has been encountered, then the placement report generator 139 proceeds to block 226 in which the one or more positions of any content element 193 (FIG. 2) specified within the content item 169 within a resulting publication 166 is obtained. Note that this information may be created and stored by the page layout engine 136 when it places the respective content item 169 into the corresponding publication 166. In this respect, the placement report generator 139 may request the precise position of the respective content element from the page layout engine 136 or may obtain the same information from a file or database that is stored in the memory 126 (FIG. 1). Thereafter, in box 229, the placement report 146 is generated.

In generating the placement report 146 in box 229, the placement report generator 139 first creates a blank placement report and then writes the position information and the corresponding placement report identifier thereto. Note that other information may be written to the blank placement report 146, as was described previously. Ultimately, the complete placement report 146 is thus created in box 229. Thereafter in box 233, the placement report 146 is stored in the placement report database 143 after which, the placement report generator 139 ends accordingly.

Although the placement report generator 139 of the present invention is embodied in software or code executed by general purpose hardware as discussed above, as an alternative the placement report generator 139 may also be embodied in dedicated hardware or a combination of software/general purpose hardware and dedicated hardware. If embodied in dedicated hardware, the placement report generator 139 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 5 shows the architecture, functionality, and operation of an implementation of the placement report generator 139. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow chart of FIG. 5 is relatively self-explanatory and are understood by those with ordinary skill in the art to the extent that software and/or hardware can be created by one with ordinary skill in the art to carry out the various logical functions as described herein.

Also, where the placement report generator 139 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the placement report generator 139 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A method for tracking a placement of a content element in a publication, comprising:
detecting at least one placement tag associated with the content element in a computer system, the content element comprising at least a portion of a content item to be placed in the publication;
determining at least one position in the publication at which the content element is placed when the at least one placement tag is detected; and
generating a placement report that logs the at least one position of the content element within the publication.

2. The method of claim 1, further comprising placing the content item in the at least one position in the publication.

3. The method of claim 1, wherein the step of generating the placement report that logs the at least one position of the content element within the publication further comprises:
identifying a placement report identifier associated with the at least one placement tag; and
writing the placement report identifier to the placement report.

4. The method of claim 1, wherein:
the step of determining the at least one position in the publication at which the content element is placed when the at least one placement tag is detected further comprises determining the at least one position of the content element in terms of a set of rectangular coordinates and an area; and
the step of generating the placement report that logs the at least one position of the content element within the publication further comprises:
generating a blank placement report in a memory; and
writing the set of rectangular coordinates and the area to the blank placement report.

5. The method of claim 1, further comprises drawing an association between the at least one placement tag and the content element.

6. The method of claim 5, wherein the step of drawing the association between the at least one placement tag and the content element further comprises identifying the at least one placement tag as an attribute associated with the content element.

7. The method of claim 5, wherein the step of drawing the association between the at least one placement tag and the content element further comprises identifying the content element encapsulated between a pair of placement tags.

8. A program embodied in a computer readable medium for tracking a placement of a content element in a publication, comprising:
code that detects at least one placement tag associated with the content element, the content element comprising at least a portion of a content item to be placed in the publication;
code that determines at least one position in the publication at which the content element is placed when the at least one placement tag is detected; and
code that generates a placement report that logs the at least one position of the content element within the publication.

9. The program embodied in the computer readable medium of claim 8, further comprising a page layout engine that places the content item in the at least one position in the publication.

10. The program embodied in the computer readable medium of claim 8, wherein the code that generates the placement report that logs the at least one position of the content element within the publication further comprises:
code that identifies a placement report identifier associated with the at least one placement tag; and
code that writes the placement report identifier to the placement report.

11. The program embodied in the computer readable medium of claim 8, wherein:
the code that determines the at least one position in the publication at which the content element is placed when the at least one placement tag is detected further comprises code that determines the at least one position of the content element in terms of a set of rectangular coordinates and an area; and
the code that generates the placement report that logs the at least one position of the content element within the publication further comprises:
code that generates a blank placement report in a memory; and
code that writes the set of rectangular coordinates and the area to the blank placement report.

12. The program embodied in the computer readable medium of claim 8, further comprises code that associates the at least one placement tag with the content element.

13. The program embodied in the computer readable medium of claim 12, wherein the code that associates the at least one placement tag with the content element further comprises code that identifies the at least one placement tag as an attribute associated with the content element.

14. The program embodied in the computer readable medium of claim 12, wherein the code that associates the at least one placement tag with the content element further comprises code that identifies the content element encapsulated between a pair of placement tags.

15. A system for tracking a placement of a content element in a publication, comprising:
means for detecting at least one placement tag associated with the content element, the content element comprising at least a portion of a content item to be placed in the publication;
means for determining at least one position in the publication at which the content element is placed when the at least one placement tag is detected; and
means for generating a placement report that logs the at least one position of the content element within the publication.

16. The system of claim 15, further comprising means for placing the content item in the at least one position in the publication.

17. The system of claim 15, wherein the means for generating the placement report that logs the at least one position of the content element within the publication further comprises:
means for identifying a placement report identifier associated with the at least one placement tag; and
means for writing the placement report identifier to the placement report.

18. The system of claim 15, wherein:
the means for determining the at least one position in the publication at which the content element is placed when the at least one placement tag is detected further comprises means for determining the at least one position of the content element in terms of a set of rectangular coordinates and an area; and
the means for generating the placement report that logs the at least one position of the content element within the publication further comprises:
means for generating a blank placement report in a memory; and
means for writing the set of rectangular coordinates and the area to the blank placement report.

19. The system of claim 15, further comprises means for associating the at least one placement tag with the content element.

20. The system of claim 19, wherein the means for associating the at least one placement tag with the content element further comprises means for identifying the at least one placement tag as an attribute associated with the content element.

21. The system of claim 19, wherein the means for associating the at least one placement tag with the content element further comprises means for identifying the content element encapsulated between a pair of placement tags.

22. A method for tracking a placement of a content element in a publication, comprising:
detecting at least one placement tag associated with the content element in a computer system, the content element comprising at least a portion of a content item to be placed in the publication;
placing the content item in the at least one position in the publication;
determining at least one position in the publication in terms of a set of rectangular coordinates and an area at which the content element is placed when the at least one placement tag is detected; and
generating a placement report that logs the at least one position of the content element within the publication by:
generating a blank placement report;
writing the set of rectangular coordinates and the area to the placement report;
identifying a placement report identifier associated with the at least one placement tag; and
writing the placement report identifier to the placement report.

23. A system for tracking a placement of a content element in a publication, comprising:
a processor circuit having a processor and a memory;
a placement report generator stored in the memory and executable by the processor, the placement report generator comprising:
logic that detects at least one placement tag associated with the content element, the content element comprising at least a portion of a content item to be placed in the publication;
a page layout engine that places the content item in the at least one position in the publication;
logic that determines at least one position in the publication in terms of a set of rectangular coordinates and an area at which the content element is placed when the at least one placement tag is detected; and
logic that generates a placement report that logs the at least one position of the content element within the publication, comprising:
logic that generates a blank placement report;
logic that writes the set of rectangular coordinates and the area to the placement report;
logic that identifies a placement report identifier associated with the at least one placement tag; and
logic that writes the placement report identifier to the placement report.
